(19) United States
(12) Patent Application Publication
(10) Pub. No.: US 2026/0142490 A1
(43) Pub. Date: May 21, 2026

(54) CELL BALANCING METHOD AND DEVICE FOR ECO-FRIENDLY VEHICLE BATTERIES

(71) Applicants: HYUNDAI MOTOR COMPANY, Seoul (KR); KIA CORPORATION, Seoul (KR)

(72) Inventor: Yeol Mae Yeo, Hwaseong-si (KR)

(73) Assignees: HYUNDAI MOTOR COMPANY, Seoul (KR); KIA CORPORATION, Seoul (KR)

(21) Appl. No.: 19/225,717

(22) Filed: Jun. 2, 2025

(30) Foreign Application Priority Data
Nov. 19, 2024 (KR) 10-2024-0165598

(51) Int. Cl. H02J 7/00; B60L 15/20; B60L 58/12; B60L 58/22

(52) U.S. Cl. CPC H02J 7/96; B60L 15/2045; B60L 58/12; B60L 58/22; H02J 7/52

(57) ABSTRACT

A cell balancing method and device for eco-friendly vehicles. The cell balancing method includes: predicting a driving load, determining whether a cell balancing entry condition is satisfied, and driving an electric motor by applying a larger current load to a cell balancing target cell than to remaining cells when low-power driving for a predetermined period of time or longer is predicted and the cell balancing is required.

### CROSS-REFERENCE TO THE RELATED APPLICATION

This application claims priority to Korean Patent Application No. 10-2024-0165598, filed on Nov. 19, 2024, in the Korean Intellectual Property Office, the disclosure of which is incorporated herein by reference in its entirety.

### BACKGROUND

### Technical Field

The present disclosure relates to a battery management system, and more specifically, to a method and device for performing cell balancing for an eco-friendly vehicle battery.

### Description of the Related Art

Eco-friendly vehicles such as hybrid electric vehicles (HEVs), plug-in HEVs (PHEVs), and electric vehicles (EVs) have a built-in battery, which is a storage device for storing electrical energy, to drive a motor. In particular, the eco-friendly vehicles have a built-in high-voltage battery that is different from a low-voltage battery used in conventional internal combustion engine vehicles. Typically, such a high-voltage battery includes a plurality of unit cells and is manufactured in a module form, where a pair of external terminal tabs connected to electrodes of each cell is exposed to the outside.

When an autonomous vehicle is in an autonomous driving mode, an autonomous driving controller can control the speed and steering of the vehicle. During this time, a situation may arise in which the vehicle travels with a restricted upper power limit of the battery.

For example, the vehicle may be driven with a restricted upper battery power limit in situations where vehicle speed needs to be limited, such as when a sensor malfunctions and thus needs sensor calibration, when the vehicle is driven in reverse, when the vehicle travels in a child protection zone, when the vehicle travels in a construction zone, or when the vehicle travels in a congested section of a road. The autonomous driving controller of the vehicle controls the speed of the vehicle and limits the output of the battery when the speed is limited by itself or when a speed limit is required in a driving situation.

In an autonomous driving situation of a vehicle, the autonomous driving controller can drive the vehicle by performing cell balancing when an SoC (State of Charge) deviation occurs between battery cells. However, the conventional battery cell balancing technology has a disadvantage in that it takes an excessively long time to perform cell balancing.

The statements in this section merely provide background information related to the present disclosure and may not constitute prior art.

### SUMMARY

The present disclosure has been made in view of the above problems and aims to provide technology that can perform cell balancing more rapidly than conventional methods.

The present disclosure also performs cell balancing by adding additional load only to a battery cell or module that requires cell balancing, particularly in a situation where low battery power is expected while a vehicle travels in an autonomous driving mode.

The technical objects to be achieved in the present disclosure are not limited to the features described above, and other aspects that are not mentioned can be clearly understood by those having ordinary skill in the art from the description below.

In an aspect of the present disclosure, a cell balancing method includes: predicting a driving load of a vehicle, determining whether a cell balancing entry condition is satisfied, and driving an electric motor by applying a larger current load to at least one cell balancing target cell than to remaining cells, among a plurality cells of a battery, based on a determination that when low-power driving of the vehicle for a predetermined period of time or longer is predicted and the cell balancing is required.

In an embodiment, the cell balancing method further includes: determining the at least one cell balancing target cell based on an average State of Charge (SoC) of the plurality of cells and a first threshold proportion defined as a ratio of a number of cells, among the plurality of cells, whose SoCs deviate from the average SoC by at least a preset threshold deviation, with respect to a total number of the plurality of cells.

In an embodiment, the cell balancing method further includes: determining the at least one cell balancing target cell based on an average State of Charge (SoC) of the plurality of cells and a first threshold proportion defined as a ratio of a number of cells, among the plurality of cells, whose SoCs deviate from the average SoC by at least a preset threshold deviation, with respect to a total number of the plurality of cells.

In an embodiment, determining whether the cell balancing entry condition is satisfied includes: determining whether the at least one cell balancing target cell, whose SoC deviates from the average SoC by at least the preset threshold deviation, is present among the plurality of cells of the battery, and whether a proportion of the at least one cell balancing target cell is equal to or greater than the first threshold proportion.

In an embodiment, the cell balancing method may further include terminating the cell balancing on the basis of an SoC or consumed power of the cell balancing target cell.

In an embodiment, the cell balancing method may further include performing the cell balancing on the at least one balancing target cell. The cell balancing may be performed, by a battery manager, by applying a current load, as a cell balancing current, to the at least one cell balancing target cell during a cell balancing time. In an embodiment, the cell balancing current may be a current discharged from the at least one cell balancing target cell and set to a value higher than a discharge current corresponding to expected required output power of a vehicle in order to output some of the expected required output power of the vehicle, and the cell balancing time may be a time set to be less than a time during which the expected required output power is expected to continue.

In an embodiment, terminating the cell balancing may include terminating the cell balancing based on determining that a first termination condition is satisfied, wherein the first termination condition is a condition in which SoCs of all cells of the plurality of cells constituting the battery are less than the threshold deviation with respect to an average SoC of all cells of the battery.

In an embodiment, terminating the cell balancing may include terminating the cell balancing based on determining that a second termination condition is satisfied, wherein the second termination condition is a condition in which powers of cells subjected to cell balancing exceed the expected required output power of the vehicle, for a period less than a duration for a period less than a duration for which the required output power continues.

In accordance with another aspect of the present disclosure, a cell balancing device includes: a battery storing electrical energy for driving a vehicle and including a plurality of cells, a sensor unit including a voltage sensor for detecting voltages of the plurality of cells, a vehicle controller configured to predict a driving load of the vehicle, and a battery manager configured to determine whether a cell balancing entry condition is satisfied. In particular, when the vehicle controller predicts low-power driving for a predetermined period of time or longer and the battery manager determines that cell balancing is required, an electric motor is driven by applying a larger current load to at least one cell balancing target cell than to remaining cells, among the plurality of cells.

In an embodiment, the battery manager may determine the at least one cell balancing target cell based on an average State of Charge (SoC) of the plurality of cells and a first threshold proportion defined as a ratio of a number of cells, among the plurality of cells, whose SoCs deviate from the average SoC by at least a preset threshold deviation, with respect to a total number of the plurality of cells.

In an embodiment, the battery manager may terminate the cell balancing on the basis of an SoC or power consumption of the cell balancing target cell.

In an embodiment, The battery manager is configured to perform the cell balancing by applying a current load, as a cell balancing current, to the at least one cell balancing target cell during a cell balancing time. The cell balancing current may be a current discharged from the at least one cell balancing target cell and set to a value higher than a discharge current corresponding to expected required output power of the vehicle in order to output some of the expected required output power of the vehicle, and the cell balancing time may be a time set to be less than a time during which the expected required output power is expected to continue.

In an embodiment, the battery manager may terminate the cell balancing when a first termination condition is satisfied, wherein the first termination condition is a condition in which SoCs of all cells of the plurality of cells are less than a threshold deviation with respect to an average SoC of all cells.

In an embodiment, the battery manager may terminate the cell balancing when a second termination condition is satisfied, wherein the second termination condition is a condition in which powers of cells subjected to cell balancing exceed the expected required output power of the vehicle, for a period less than a duration for which the required output power continues.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 is a block diagram schematically illustrating a cell balancing device according to an embodiment of the present disclosure; and

FIG. 2 is a flowchart illustrating a cell balancing method according to an embodiment of the present disclosure.

### DETAILED DESCRIPTION

### Hereinafter, Embodiments Disclosed in This

specification are described in detail with reference to the attached drawings. Regardless of the drawing symbols, identical or similar components are given the same reference numerals and redundant descriptions thereof have been omitted. The suffixes “module” and “unit” of elements used in the following description are used for convenience of description and thus can be used interchangeably and do not have any distinguishable meanings or functions. Further, in the following description of the embodiments disclosed in the present specification, a detailed description of known functions and configurations incorporated herein are omitted when it may obscure the subject matter of the present disclosure. In addition, the accompanying drawings are provided only for ease of understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present disclosure, the term “comprise” or “include” specifies the presence of a stated feature, figure, step, operation, component, part or combination thereof, but does not preclude the presence or addition of one or more other features, figures, steps, operations, components, or combinations thereof.

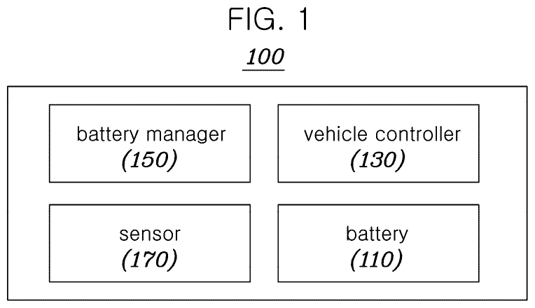

FIG. 1 is a block diagram schematically illustrating a cell balancing device according to an embodiment of the present disclosure.

Referring to FIG. 1, the cell balancing device according to the present embodiment includes a battery 110, a vehicle controller 130, a battery manager 150, and a sensor 170.

The battery 110 stores electrical energy for driving a vehicle and includes a plurality of cells.

The vehicle controller 130 predicts a driving load of the vehicle, determines whether a first condition for entering a cell balancing mode is satisfied while the vehicle is traveling in an autonomous driving or driving assistance mode, and transmits a cell balancing request signal to the battery manager 150 if the first condition is satisfied.

Here, the vehicle controller 130 may be a vehicle control unit (VCU) or a hybrid control unit (HCU) of the vehicle.

The first condition for entering the cell balancing mode may include a condition in which the vehicle is in the autonomous driving or driving assistance mode and is expected to travel with expected required output power less than preset threshold output power for a duration equal to or longer than a preset threshold time.

Here, the expected required output power of the vehicle may be defined as expected required output power, and the duration for which the vehicle is expected to travel with the expected required output power less than the threshold output power may be defined as a required output power duration.

The expected required output power of the vehicle may be set to an arbitrary value, for example, 10 kW.

In addition, the preset threshold time may be set to an arbitrary value, for example, 10 seconds.

For example, the first condition may be a condition in which the vehicle continues to travel for 10 seconds or longer with output power of less than 10 kW. At this time, if it is expected that the vehicle will enter a 30 km/h speed limit section during traveling, and if it is determined that the vehicle can travel for more than 10 seconds at 10 kW in the 30 km/h speed limit section, the vehicle controller 130 determines that the first condition is satisfied and may transmit information thereon to the battery manager 150.

The cell balancing request signal may include information on the expected required output power and the required output power duration.

Upon receiving the cell balancing request signal from the vehicle controller 130, the battery manager 150 determines whether a second condition for entering the cell balancing mode is satisfied, and enters the cell balancing mode if the second condition is satisfied.

The battery manager 150 may be a battery management system (BMS) of the vehicle.

The second condition for entering the cell balancing mode may include a condition in which the proportion of cells whose SoC deviate from the average SoC of all cells of the battery 110 by a preset threshold deviation or more is equal to or greater than a first threshold proportion. The first threshold proportion refers to a ratio of a number of cells, among the plurality of cells of the battery, whose SoCs (State of Charge) deviate from the average SoC of all cells by at least a preset threshold deviation, with respect to a total number of the plurality of cells of the battery.

Among the plurality of cells of the battery, a cell whose SoC deviates from the average SoC of all cells by the preset threshold deviation or more may be defined as a cell balancing target cell.

The preset threshold deviation may be set to an arbitrary value, for example, 3%.

In addition, the first threshold proportion may be set to an arbitrary value, for example, 10%.

In an embodiment, the battery manager 150 performs cell balancing in response to the cell balancing request signal received from the vehicle controller 130 in the cell balancing mode.

Here, the battery manager 150 may perform cell balancing by driving an electric motor by applying a current load to at least one cell balancing target cell with a cell balancing current during a cell balancing time.

The cell balancing current may be a current discharged from the cell balancing target cell and set to a value higher than the discharge current corresponding to the expected required output power of the vehicle, in order to contribute part of the expected required output power. The cell balancing time may be a time set to be less than a time during which the required output power is expected to continue.

The cell balancing current may be set to be higher than the current discharged from cells other than the cell balancing target cell.

For example, when the battery 110 has a voltage of 400 V and includes 100 cells having a capacity of 50 A, and a cell balancing entry request is received from the vehicle controller 130, the battery manager 150 may determine that the second condition for entering the cell balancing mode is satisfied if there are 10 cells whose SoC is 3% or higher than the average SoC of all cells of the battery. At this time, the battery manager 150 may determine that the 10 cells are cell balancing target cells. For example, if the expected required output power is 10 kW and the required output power duration is 10 seconds, the cell balancing current is 10,000 W/400 V=25 A. Accordingly, the battery manager 150 can apply a current load of 25 A or less to the 10 cell balancing target cells for 10 seconds or less.

The battery manager 150 determines whether a cell balancing termination condition is satisfied in the cell balancing mode, and if the cell balancing termination condition is satisfied, terminates cell balancing.

The cell balancing termination condition may include a condition in which SoCs of all cells are less than the threshold deviation with respect to the average SoC of all cells.

At this time, the second threshold proportion may be a value equal to or less than the first threshold proportion.

For example, when the battery 110 includes 100 cells, the threshold deviation is 3%, and the first threshold proportion is 10%, if there are 10 cell balancing target cells, the battery manager 150 enters the cell balancing mode, and if deviations of some of the cell balancing target cells decreases below 3% during cell balancing, terminates the cell balancing mode for the corresponding cells.

At this time, the condition in which the SoCs of all cells deviate from the average SoC of all cells by less than the threshold deviation may be defined as a first termination condition.

In addition, the cell balancing termination condition may include a condition in which powers of cells subjected to cell balancing exceed the expected required output power for a time less than the required output power duration.

Here, the condition in which the powers of the cells subjected to cell balancing exceed the expected required output power for a time less than the required output power duration may be defined as a second termination condition.

The battery manager 150 may terminate cell balancing if the first termination condition or the second termination condition is satisfied.

The sensor 170 measures the voltage of the battery 110.

At this time, the sensor 170 may measure the voltages of all cells constituting the battery 110.

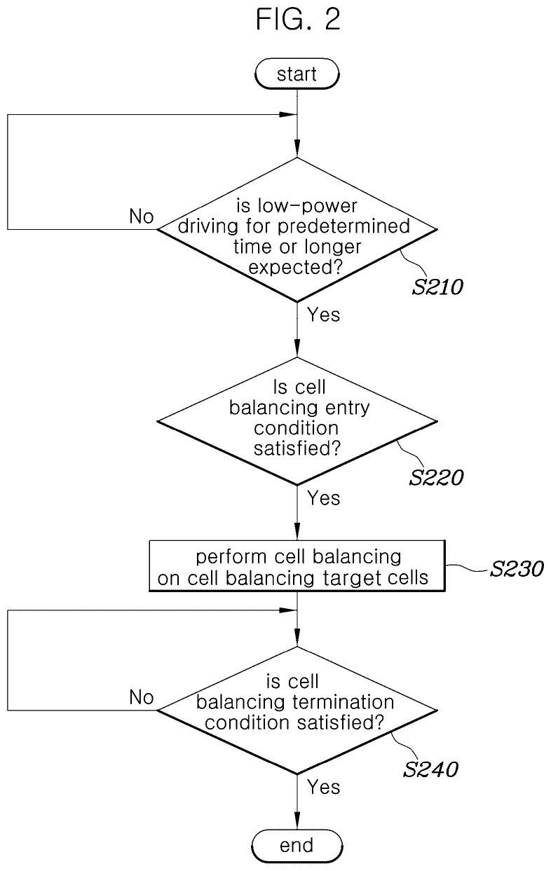

FIG. 2 is a flowchart illustrating a cell balancing method according to an embodiment of the present disclosure.

The cell balancing method according to the present embodiment may be performed by the cell balancing device 100 according to the embodiment of FIG. 1.

Referring to FIG. 2, the vehicle controller determines whether low-power driving is expected for a predetermined period of time or longer (in operation S210).

At this time, the vehicle controller 130 may determine whether the vehicle satisfies the first condition for entering the cell balancing mode in an ignition ON state. When the first condition is satisfied, the vehicle controller 130 may transmit a cell balancing request signal to the battery manager 150, and the battery manager 150 may receive the cell balancing request signal.

Here, the first condition for entering the cell balancing mode may include a condition in which the vehicle is in the autonomous driving or driving assistance mode and is expected to continuously travel with expected required output power lower than preset threshold output power for a duration exceeding a preset threshold time.

The expected required output power of the vehicle may be defined as expected required output power, and the expected driving duration of the vehicle may be defined as a required output power duration.

The cell balancing request signal may include information on the expected required output power and the required output power duration.

Upon receiving the cell balancing request signal from the vehicle controller 130, the battery manager 150 determines whether cell balancing target cells exist at or above the first threshold proportion (in operation S220).

A cell whose SoC deviates from the average SoC of all cells by a preset threshold deviation may be designated as a cell balancing target cell.

The preset threshold deviation may be set to an arbitrary value, for example, 3%.

The first threshold proportion may be set to an arbitrary value, for example, 10%.

In addition, the battery manager 150 performs cell balancing on the identified cell balancing target cell(s) (in operation S230).

The battery manager 150 may perform cell balancing on the basis of the cell balancing request signal received from the vehicle controller 130.

In particular, cell balancing may be performed by the battery manager 150 by applying a current load, as a cell balancing current, to the cell balancing target cells during a cell balancing time, thereby driving an electric motor.

The cell balancing current may be a current discharged from the cell balancing target cells and set to a value higher than the discharge current corresponding to the required output power, in order to contribute part of the expected required output power of the vehicle. The cell balancing time may be a time set to be less than the time for which the required output power is expected to continue.

In an embodiment, the cell balancing current may be set to a current higher than the current discharged from cells other than the cell balancing target cells of the battery.

For example, when the battery 110 has a voltage of 400 V and includes 100 cells having a capacity of 50 A, and a cell balancing entry request is received from the vehicle controller 130, the battery manager 150 may determine that the second condition for entering the cell balancing mode is satisfied if there are 10 cells whose SoC is 3% or lower than the cell with the highest SoC. At this time, the battery manager 150 may determine that the 10 cells are cell balancing target cells. For example, if the expected required output power is 10 kW and the required output power duration is 10 seconds, the cell balancing current is 10,000 W/400 V=25 A. Accordingly, the battery manager 150 can apply a current load of 25 A or less to the 10 cell balancing target cells for 10 seconds or less.

The battery manager 150 determines whether a cell balancing termination condition is satisfied (in operation S240), and if the cell balancing termination condition is satisfied, terminates cell balancing.

The cell balancing termination condition may include a condition in which SoCs of all cells are less than the preset threshold deviation with respect to the average SoC of all cells.

The second threshold proportion may be a value equal to or less than the first threshold proportion.

For example, when the battery 110 includes 100 cells, the threshold deviation is 3%, and the first threshold proportion is 10%, if there are 10 cell balancing target cells, the battery manager 150 enters the cell balancing mode, and if deviations of some of the cell balancing target cells decreases below 3% during cell balancing, terminates the cell balancing mode for the corresponding cells.

At this time, the condition in which the SoCs of all cells deviate from the average SoC of all cells by less than the threshold deviation may be defined as a first termination condition.

In addition, the cell balancing termination condition may include a condition in which powers of cells subjected to cell balancing exceed the expected required output power for a time less than the required output power duration.

Here, the condition in which the powers of the cells subjected to cell balancing exceed the expected required output power for a time less than the required output power duration may be defined as a second termination condition.

The battery manager 150 may terminate cell balancing if the first termination condition or the second termination condition is satisfied.

According to the embodiments of the present disclosure described above, cell balancing can be performed more rapidly than when using conventional technology.

In addition, in a situation in which low battery output power is expected while a vehicle is traveling in the autonomous driving mode, cell balancing can be performed by adding an additional load only to battery cells or modules that require cell balancing.

The above-described present disclosure can be implemented as computer-readable code on a medium in which a program is recorded. Computer-readable media include all kinds of recording devices in which data that can be read by a computer system is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc. Therefore, the above detailed description should not be construed as limiting in all aspects but should be considered as illustrative. The scope of the present disclosure should be determined by a reasonable interpretation of the appended claims, and all changes within the equivalent scope of the present disclosure are included in the scope of the present disclosure.

According to various embodiments of the present disclosure described above, it is possible to perform cell balancing more rapidly than when using conventional technologies.

Furthermore, it is possible to perform cell balancing by adding additional load only to a battery cell or module that requires cell balancing in a situation in which low battery power is expected while a vehicle travels in an autonomous driving mode.

The effects that can be obtained from the present disclosure are not limited to the effects mentioned above, and other effects not mentioned can be clearly understood by those having ordinary skill in the art from the description below.

What is claimed is:

1. A cell balancing method comprising:
predicting a driving load of a vehicle;
determining whether a cell balancing entry condition is satisfied; and
driving an electric motor by applying a greater current load to at least one cell balancing target cell than to remaining cells, among a plurality cells of a battery, based on a determination that low-power driving of the vehicle for a predetermined period of time or longer is predicted and the cell balancing is required.

2. The cell balancing method of claim 1, further comprising:
determining the at least one cell balancing target cell based on an average State of Charge (SoC) of the plurality of cells and a first threshold proportion defined as a ratio of a number of cells, among the plurality of cells, whose SoCs deviate from the average SoC by at least a preset threshold deviation, with respect to a total number of the plurality of cells.

3. The cell balancing method of claim 2, wherein determining whether the cell balancing entry condition is satisfied comprises:
determining whether the at least one cell balancing target cell, whose SoC deviates from the average SoC by at least the preset threshold deviation, is present among the plurality of cells of the battery, and whether a proportion of the at least one cell balancing target cell is equal to or greater than the first threshold proportion.

4. The cell balancing method of claim 2, further comprising performing the cell balancing on the at least one balancing target cell,
wherein the cell balancing is performed, by a battery manager, by applying a current load, as a cell balancing current, to the at least one cell balancing target cell during a cell balancing time.

5. The cell balancing method of claim 4,
wherein the cell balancing current is a current discharged from the at least one cell balancing target cell and set to a value greater than a discharge current corresponding to expected required output power of the vehicle in order to output some of the expected required output power of the vehicle, and the cell balancing time is a time set to be less than a time during which the expected required output power is expected to continue.

6. The cell balancing method of claim 5, further comprising terminating the cell balancing based on the SoC or consumed power of the at least one cell balancing target cell.

7. The cell balancing method of claim 6, wherein terminating the cell balancing comprises:
terminating the cell balancing based on determining that a first termination condition is satisfied, wherein the first termination condition is a condition in which SoCs of all cells of the plurality of cells are less than the threshold deviation with respect to the average SoC of the plurality of cells is satisfied.

8. The cell balancing method of claim 6, wherein terminating the cell balancing comprises terminating the cell balancing based on determining that a second termination condition is satisfied, wherein the second termination condition is a condition in which powers of cells subjected to cell balancing exceed the expected required output power of the vehicle, for a period less than a duration for which the required output power continues.

9. A cell balancing device comprising:
a battery configured to store electrical energy for driving a vehicle and including a plurality of cells;
a sensor unit including a voltage sensor configured to detect voltages of the plurality of cells;
a vehicle controller configured to predict a driving load of the vehicle; and
a battery manager configured to determine whether a cell balancing entry condition is satisfied,
wherein, when the vehicle controller predicts low-power driving for a predetermined period of time or longer and the battery manager determines that cell balancing is required, an electric motor is driven by applying a greater current load to at least one cell balancing target cell than to remaining cells, among the plurality of cells.

10. The cell balancing device of claim 9, wherein the battery manager is configured to determine the at least one cell balancing target cell based on an average State of Charge (SoC) of the plurality of cells and a first threshold proportion defined as a ratio of a number of cells, among the plurality of cells, whose SoCs deviate from the average SoC by at least a preset threshold deviation, with respect to a total number of the plurality of cells.

11. The cell balancing device of claim 10, wherein the battery manager is configured to perform the cell balancing by applying a current load, as a cell balancing current, to the at least one cell balancing target cell during a cell balancing time.

12. The cell balancing device of claim 9, wherein the battery manager is configured to terminate the cell balancing based on a State of Charge (SoC) or power consumption of the at least one cell balancing target cell.

13. The cell balancing device of claim 12, wherein the battery manager is configured to terminate the cell balancing when a first termination condition is satisfied, wherein the first termination condition is a condition in which SoCs of all cells of the plurality of cells are less than a threshold deviation with respect to an average SoC of all cells.

14. The cell balancing device of claim 13,
wherein the cell balancing current is a current discharged from the at least one cell balancing target cell and set to a value greater than a discharged current corresponding to expected required output power of the vehicle in order to output some of the expected required output power of the vehicle, and the cell balancing time is a time set to be less than a time during which the expected required output power is expected to continue.

15. The cell balancing device of claim 14, wherein the battery manager is configured to terminate the cell balancing when a second termination condition is satisfied, wherein the second termination condition is a condition in which powers of cells subjected to cell balancing exceed the expected required output power of the vehicle, for a period less than a duration for which the required output power continues.
